(19) United States
(12) Patent Application Publication
(10) Pub. No.: US 2005/0084592 A1
(43) Pub. Date: Apr. 21, 2005

(54) Satiety enhancing food compositions

(75) Inventors: Deborah Lynne Aldred, Bedford (GB); Ivo Antonius Van Amerongen, Vlaardingen (NL); Janos Bodor, Vlaardingen (NL); David Jason Mela, Vlaardingen (NL); Phillippa Rayment, Bedford (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Slim-Fast Foods Company, Division of Conopco, Inc.

(21) Appl. No.: 10/932,387

(22) Filed: Sep. 2, 2004

(30) Foreign Application Priority Data
Sep. 3, 2003 (EP) 03255495.8

(51) Int. Cl. A23L 1/05

(52) U.S. Cl. 426/573

(57) ABSTRACT

The present invention provides an aqueous liquid or spoonable edible composition comprising at least 1% wt protein and from 0.1 to 5% wt of a biopolymer thickening agent which is not denatured or hydrolysed between pH 2 and 4, and wherein the composition has a gel strength at 37° C. and pH 2 of at least 10 KPa. The compositions of the invention have good satiety effects and are beneficial for use in weight control plans.

### FIELD OF INVENTION

The present invention relates to food composition having an enhanced satiety effect, particularly aqueous liquid or spoonable compositions comprising a biopolymer thickening agent.

### BACKGROUND OF THE INVENTION

The incidence of obesity and the number of people considered overweight in countries where a so-called Western diet is adopted has drastically increased over the last decade. Since obesity and being overweight are generally known to be associated with a variety of diseases such as heart disease, type 2 diabetes, hypertension and arthereosclerosis, this increase is a major health concern for the medical world and for individuals alike. Furthermore, being overweight is considered by the majority of the Western population as unattractive.

This has led to an increasing interest by consumers in their health and has created a demand for products that help to reduce or control daily caloric intake and/or control body weight and/or bodily appearance.

Several solutions have been proposed to help individuals to control their weight. Among these solutions is the use of drugs e.g. to suppress the activity of enzymes in the digestive system. However the use of drugs is often not preferred unless strictly required for medical purposes.

Another proposed solution is to prescribe the individuals a specific diet, for example, a diet with a restricted caloric intake per day. A problem with these diets is that often they do not provide a healthy nutritional balance and/or they are difficult to accommodate in modern lifestyles.

Meal replacer products have also been proposed as part of a healthy diet in order to control or reduce body weight. For example, U.S. Pat. No. 5,688,547 discloses a nutritional meal replacement composition comprising dietary fibre, protein, a cellulose gum and gel.

These meal replacer products are generally products that are intended to be consumed as a single-serving food product, such as a bar, drink etc to replace one or two meals per day. The meal replacer products are designed such that on the one hand they provide a restricted caloric intake, but on the other hand they provide a healthy balance of nutritional ingredients and are convenient to incorporate into an individual's daily diet.

However, a general problem with products intended to be used in a weight loss or weight maintenance plan, e.g. meal replacer products or low-calorie snacks, is that feelings of hunger may occur sooner than desired after consumption and/or the feeling of satiety obtained may not be as great as desired. Both of these considerations may render it difficult for the individual to adhere to the plan or it may make it and/or the products used therein less appealing to consumers.

Recognising the demand for effective and convenient satiety-inducing food products, research has been carried out to try to address the problems associated with the above approaches to controlling or reducing body weight.

One approach to addressing the aforementioned problems has been to investigate the use of satiety agents in food products in order to increase the satiety effect obtained from consuming a food product comprising the satiety agents.

WO 01/17541 discloses a composition comprising proteins, high levels of calcium, medium or long chain fatty acids and a source of a proteinase inhibitor extracted from potatoes to promote satiety.

WO 99/02041 discloses a food composition giving a prolonged feeling of satiety and comprising a mixture of specific triglyceride oils and a food emulsifier.

WO 01/17377 discloses uronic acid-containing polysaccharides cross-linked to each other to form a sponge-like structure that dissolves poorly in water and gastro-intestinal fluids, and which are poorly reabsorbed, in order to provide a satiety effect.

Another approach to reduce the feeling of hunger which has been suggested is to use the principle of the ileal brake. The ileal brake principle itself is described by Gregg W. Van Citters in The Ileal Brake: A fifteen-year progress report, Current Gastronenterology Reports 1999, I:4040-409 and which concerns the delivery of satiety agents to parts of the gut e.g the ileum, duodenum or jejunum.

However, the above developments are generally complicated and/or expensive and/or not as effective as is desired.

Another problem in the formulation of the above types of food products is that it is often not desirable to include ingredients which may create a negative impression on the consumer when declared on the pack, or, which are not suitable for incorporation in food products e.g. certain synthetic polymers.

To provide simpler solutions to the problem of providing good satiety effects, natural fibres have been disclosed for use in food compositions for the purpose of enhancing satiety. U.S. Pat. No. 4,198,400 discloses the use of dietary fibres in juice and soup compositions to aid a feeling of satiety.

WO 02/096223 discloses a method of blunting the post-prandial glycemic response in humans by feeding an induced viscosity fibre system. The system comprises a lightly hydrolysed starch, a soluble dietary fibre source and acid-soluble multi-valent cations. Digestive enzymes act upon the lightly hydrolysed starch to produce an increase in viscosity of the system. Gel strength determined using the gel strength test described herein was found to be less than 2000 Pa.

U.S. Pat. No. 5 866 190 discloses beverages comprising up to 0.2% wt of a mixture of pectin and alginate as a stabiliser. The acidic beverages disclosed have a very low viscosity and do not form gels at pH 2.0.

WO 92/09212 discloses liquid compositions consisting of a surfactant, water and a water soluble, non-ionic cellulose ether having a cloud point of no greater than 35° C. The composition are disclosed to be suitable for use as a slimming aid.

U.S. Pat. No. 5 283 076 and U.S. Pat. No. 5 324 526 disclose beverage formulations that may be used as health foods. The beverages preferably comprise 5-20% wt of low molecular weight alginates. Use of these alginates in the prevention of obesity is proposed. Very weak gels are formed at pH 2.0 using the gel strength test described herein and the gels are too soft to be measured.

U.S. Pat. No. 5,688,547 discloses shakes, puddings or mousses comprising protein, cellulose gel and gum and dietary fibres including pectin, alginate, gum arabic and guar gum.

EP-A-323,510 discloses a food composition comprising water-soluble edible fibres and proteins which are reported to be useful for the prevention of over-eating. The dietary fibres and proteins are used in a ratio such that a weak gel is formed when an aqueous solution of the composition is in contact with gastric juice. The gel strength of the composition is less than 10 Kpa according to the gel strength test of the present invention.

WO 01/56404 discloses that 0.01 to 5% wt of a low molecular weight polymannuronate derived from alginate may be used in a functional beverage.

U.S. Pat. No. 2003/0013679 and WO 02/096353 disclose a method of blunting the post-prandial glycemic response in humans by feeding an induced viscosity fibre system. The systems comprise a lightly hydrolysed starch and a soluble dietary fibre source in amounts of at least 10% wt. Digestive enzymes act upon the lightly hydrolysed starch to produce an increase in viscosity of the system.

WO 00/67592 discloses methods of producing low viscosity glucomannan comprising compositions by mixing maltodextrin with konjac flour. This is said to provide for the conversion of a food or beverage product from an initial low viscosity substance to a high viscosity end-product.

Marciani et al in the paper “Assessment of antral grinding of a model solid meal with echo-planar imaging”, 2001 American Journal Physiology-Gastrointestinal and Liver Physiology, pg 844-G849 disclose that the maximum force exerted by the gastric antrum is close to 0.65N. The sense of fullness after ingesting a low viscosity meal containing pre-formed agar beads directly correlated with increasing bead hardness. The objective of the invention described herein is the formation of gelled particles in the stomach after consumption of a liquid or spoonable composition.

Wolf et al in the paper “Glycemic and insulinemic responses of non-diabetic healthy adult subjects to an experimental acid-induced viscosity complex incorporated into a glucose beverage”, Nutrition, Volume 18, numbers 7/8, 2002, disclose an acid induced viscosity complex comprising alginates. The viscosity of the compositions tested (which did not comprise protein) rose between pH 5 and 4 but then showed a sharp decrease in viscosity at below 4.

EP-A-333,858 discloses a food composition having a reduced amount of carbohydrate and containing water soluble edible fibers and proteins in such an amount that when an aqueous solution of the food comes into contact with a gastric juice the solution will gel. The compositions have been found to only form a weak gel on contact with gastric juice.

U.S. Pat. No. 2002/0193344-A1 discloses a method of blunting the post prandial glycemic response to a meal by feeding an acid controlled induced fibre system comprising an anionic soluble fibre and water-insoluble, acid-soluble multivalent cations. The compositions have been found to only form a weak gel according to the gel strength test of the present invention.

U.S. Pat. No. 2003/118712-A1 and U.S. Pat. No. 2003/0198726-A1 disclose liquid compositions having a pH of more than 6 and comprising pectin and/or alginate, calcium and indigestible oligosaccharide. The compositions have been found to form a very weak gel, if any at all, according to the gel strength test of the present invention WO 02/096223 discloses a method of blunting the post-prandinal glycemic response to a meal by feeding a dual induced viscosity fibre system. The system comprises soluble fibre and water-insoluble, acid-soluble multivalent cations. The compositions have been found to only form a weak gel according to the gel strength test of the present invention.

JP 04/023,968 discloses food compositions comprising a water-insoluble dietary fibre and calcium compound which in insoluble in a neutral region. An aqueous solution comprising the compositions are said to gel when contacting gastric juice. The compositions comprise very low levels of protein, if any.

Alginates are known for use in food products as a gelling agent. See for example: FR-A-2,649,299, GB-A-1,428,362, GB-A-1,369,199 and GB-A-1,531,219.

However, the satiety effect obtained by the above compositions is often not optimal and thus there is still a need in the art for edible compositions that provide a good satiety effect for consumers, especially those wishing to control their calorie intake and/or body weight.

In particular, there is a need for compositions which provide good satiety effects, which are of acceptable taste and texture for the consumer, which are convenient and/or economical to manufacture and which are stable during manufacture and storage. This is especially applicable to meal replacement products or other calorie-controlled products intended to be consumed as part of a weight loss or weight control plan.

The present invention seeks to address one or more of the above-mentioned problems.

In particular, it is an object of the invention to provide food products that have a good satiety effect. It is also an object of the invention to provide food products to be used in a method of preventing or treating obesity, especially human obesity.

It is a further object of the invention to provide food products which address one or more of the above mentioned problems and which comprise conventional, preferably natural, food ingredients.

It is a further object of the invention to provide food products, especially meal replacer products and products to be used in a weight loss or weight control plan, that have an improved satiety effect compared to conventional types of such food products.

It is also an object of the invention to provide a method, and food products to be used therein, to aid an individual adhere to a weight loss or weight control plan (e.g. a calorie controlled diet), and/or to control body weight and/or to improve or maintain the perception of body image or body weight.

It is also an object of the invention to provide food products which can be prepared by, and which are not substantially negatively affected by, conventional food processing and food preparation techniques.

In particular, there is a need for food products, especially meal replacer products and food products to be used as part of a weight loss or weight control plan which address one or more of the above problems.

### SUMMARY OF THE INVENTION

Surprisingly we have now found that by including biopolymers in food compositions comprising protein and controlling the gel strength of those compositions under gastric conditions excellent results are obtained, especially with respect to satiety effects.

Thus according to a first aspect, the present invention provides an aqueous liquid or spoonable edible composition comprising at least 1% wt protein and from 0.1 to 5% wt of a biopolymer thickening agent which is not denatured or hydrolysed between pH 2 and 4, and wherein the composition has a gel strength at 37° C. and pH 2 of at least 10 KPa.

According to a second aspect, the invention provides The use of a biopolymer thickening agent which is not denatured or hydrolysed between pH 2 and 4 in the manufacture of an aqueous liquid or spoonable edible composition comprising at least 1% wt and having a protein gel strength at 37° C. and pH 2 of at least 10 KPa, for use in providing an enhanced feeling of satiety to a person consuming the edible composition and/or to aid adherence to a weight loss or weight control plan and/or in a method of preventing or treating obesity or being overweight.

According to a third aspect, the invention provides a method for inducing satiety in a human or animal, the method comprising the step of administering to a human or animal an aqueous liquid or spoonable edible composition comprising at least 1% wt protein and from 0.1 to 5% wt of a biopolymer thickening agent which is not denatured or hydrolysed between pH 2 and 4, the edible composition having a gel strength at 37° C. and pH 2 of at least 10 KPa.

Depending upon the type of food product, it is preferred that the edible composition has a maximum gel strength at 37° C. and pH 2 of 100 KPa.

It is further preferred that the edible composition comprises a polysaccharide continuous phase, which continuous phase comprises at least a part of the biopolymer thickening agent, preferably from 0.5 to 10% wt of the based on the weight of the polysaccharide continuous phase.

It has been found that the presence of proteins in the edible compositions of the invention aids in the formation of the required gel strength according to the invention. Furthermore, the presence of both the protein and the biopolymer thickening agent is believed to have beneficial effects upon satiety, possibly, through changes to nutrient delivery in the small intestines. Without wishing to be bound by theory, it is believed that the claimed gel strength is formed in the stomach of the person consuming the edible composition of the invention, and leads to distension of the stomach which may lead to an increased satiety effect.

Preferably the biopolymer thickening comprises an ionic non-starch polysaccharide, most preferably selected from alginates, pectins, carrageenans, amidated pectins, xanthans, gellans, furcellarans, karaya gum, rhamsan, welan, gum ghatti, gum arabic and salts or mixtures thereof. Alginates having a L-guluronic acid content of at least 60% are the most preferred ionic non-starch polysaccharides.

Preferably the edible composition is a meal replacer or other food composition intended to be used in a weight loss or weight control plan.

The present invention provides an effective and convenient method of providing good satiety effects to food compositions, especially those intended to be used in a weight loss or weight control plan. Furthermore, the products can be manufactured by conventional techniques and are economical to produce. They are also stable upon storage.

The advantages of the present invention include a good satiety effect after consumption of a food composition according to the invention; for example an enhanced feeling of satiety, feeling satiated sooner whilst eating and/or remaining satiated for a longer period of time after eating. These advantages are especially beneficial for the compliance with weight loss or weight control plans and/or the control or maintenance of body weight and/or body perception. There are also longer-term advantages associated with helping in the prevention of diseases related to being overweight.

The term “meal replacer” or “meal replacement products” as used herein refer to products (compositions) which are intended to replace one or more conventional meals a day as part of a weight loss or weight plan; they are of a controlled calorie content and are generally eaten as a single product or portion.

The term “comprising” is not meant to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

Spoonable edible compositions according to the invention typically display at 20° C. the following characteristics:
(a) a yield value (also called: yield stress) of more than 50 Pa extrapolated from shear rates between 100 and 300 s⁻¹ (Bingham)
(b) a Bingham viscosity of less than 500 mPa.s between shear rates of 100 and 300 s⁻¹.

Yield stress and Bingham viscosities may be determined utilising the Carrimed Rheometer. Measurements are performed at 5° C. using 4° C. cone and plate geometry. The shear stress is increased from zero at a rate of 60 Pa/min and shear rates are measured until values in excess of 600 s⁻¹ are achieved. The measurement is then terminated. A graph of shear stress vs. shear rate is plotted and a straight line fitted to the curve between the shear rates of 100 to 300 s⁻¹. The slope of this line is the Bingham viscosity. The yield stress is determined by extrapolation of this line back to zero shear rate.

Except in the operating and comparative examples, or where otherwise explicitly indicated, all numbers in this description indicating amounts of material or conditions of reaction, physical properties of materials and/or use are to be understood as modified by the word “about.” All amounts are by weight, based on the total weight of the relevant product, unless otherwise specified.

Unless stated otherwise or required by context, the terms “fat” and “oil” are used interchangeably herein.

A feeling of satiety as referred to herein means a greater or enhanced feeling of satiety (satiation) after eating and/or a longer lasting feeling of satiety after eating. Such effects typically reduce feelings of hunger and/or extend the time between food intake by an individual and can result in a smaller amount of food and/or fewer calories consumed in a single or subsequent sitting. The references herein to satiety include both what is strictly referred to as satiation and satiety, including end of meal satiety and between meals satiety. Satiety may also be perceived by an individual as a feeling of ‘fullness’, reduced hunger and/or reduced appetite.

### DETAILED DESCRIPTION OF INVENTION

Gel Strength

It has been found, according to the present invention, that when liquid or spoonable edible compositions comprise a certain amount of protein and biopolymer thickening agents and have a certain gel strength as herein defined, advantageous satiety effects are obtained.

The edible compositions according to the invention have a gel strength at 37° C. and pH 2 of at least 10 KPa, preferably of at least 11 KPa, most preferably of at least 15 KPa, such as of at least 20 KPa.

The edible compositions preferably have a maximum gel strength as herein defined at 37° C. and pH 2 of 100 KPa, preferably of 50 KPa.

The gel strength value referred to herein is a measure of the strength of the gel that is formed in the stomach of the individual upon consumption of the compositions of the invention. When the gel strength as according to the present invention is achieved, the satiety effect of the edible compositions is enhanced.

The gel strength as referred to herein is determined according to the following test procedure using large deformation rheology at 37° C.

Gel strength test method;
1. Samples of the edible composition are prepared by mixing a sufficient amount of glucono-delta-lactone (a food grade acidulant) with the edible composition to produce a pH of 2 after two hours in the mould as described below. The glucono-delta-lactone is added to the composition with stirring with a suitable stirrer, e.g. a magnetic stirrer at 37° C. The mixed solution is then poured into pre-prepared Teflon moulds of approximately 12 mm×12 mm (greased with olive oil).
2. The samples are incubated at 37° C. for 2 hours and then removed from the moulds.
3. Flat plate compression tests are performed using an Instron Universal Testing Machine. The experiments are undertaken using a 0.01 kN load cell and a crosshead speed of 10 mm/min. Force-displacement data are converted into true stress (Pa)/strain plots using the sample dimensions, where Stress=Force/Area and Strain=Displacement/Original length to give the gel strength result in Pa. The gel strength was determined from the maximum stress before fracture of the sample.

Biopolymer Thickening Agent

The edible composition comprises an amount of from 0.1 to 5% wt of the biopolymer thickening agent based on the weight of the composition, more preferably 0.4 to 4% wt, most preferably 0.5 to 3% wt, especially 1 to 2% wt. Where the biopolymer thickening agent is a carbohydrate the amounts of carbohydrate given hereinbelow, and the calories therefrom, are inclusive of the amount of biopolymer thickening agent that is present in the compositions.

Preferably the edible composition comprises a polysaccharide continuous phase comprising at least a part of the biopolymer thickening agent. The phase volume of the polysaccharide continuous phase is preferably in the range of from 30 to 60% of the total volume of the edible composition, more preferably 35 to 50%. The phase volume can be calculated from confocal scanning laser microscopy (CSLM) using suitable image analysis software as is readily available. This can be used to calculate the percentage of the biopolymer thickening agent in the polysaccharide continuous phase. It is preferred that the polysaccharide continuous phase comprises from 0.5 to 10% wt of the biopolymer thickening agent based on the weight of the polysaccharide continuous phase, more preferably 1 to 7% wt, most preferably 1.5 to 5% wt.

Alginate is the biopolymer thickening agent preferably found in the polysaccharide continuous phase.

It is preferred that the biopolymer thickening agent comprises a non-starch polysaccharide.

It has been found, according to the present invention, that especially good results for satiety are obtained when the biopolymer thickening agent comprises an ionic, especially anionic, or neutral non-starch polysaccharide or a mixture thereof. Especially preferred are ionic non-starch polysaccharides either on their own or in combination with other biopolymers.

Especially preferred ionic non-starch polysaccharides are alginates, pectins, carrageenans, amidated pectins, xanthans, gellans, furcellarans, karaya gum, rhamsan, welan, gum ghatti, gum arabic and salts or mixtures thereof. Of these, alginates are especially preferred either on their own or in combination with other biopolymers. Suitable salts include the alkaline and alkaline earth metal salts, especially sodium, potassium, calcium or magnesium salts.

According to one aspect of the invention, ionic, especially anionic, non-starch polysaccharides in an amount of 0.5 to 3% wt, based on the weight of the composition are preferred.

It is preferred that these ionic non-starch polysaccharides have a weight average molecular weight of at least 0.5×10⁵, more preferably of at least 1×10⁵, most preferably of at least 2×10⁵, such as at least 2.5×10⁵. It is also preferred that these alginates have a molecular weight of up to 5×10⁵, more preferably of up to 4.5×10⁵, most preferably of up to 4×10⁵.

According to one embodiment of the present invention, alginates having an L-guluronic acid content of at least 60% of the total uronic acid units in the alginate, preferably of at least 65%, most preferably of at least 67% are preferred. Preferably the alginates having a guluronic acid content of up to 75%. Suitable alginates according to this embodiment include the commercially available alginates Protanal LF5/60™ (available from FMC Biopolymer) and Manugel DMB™ (available from ISP/Kelco). Alginates are naturally occurring linear co-polymers of L-guluronic acid and D-mannuronic acid. According to the present invention it has been found that compositions comprising such alginates provide especially good satiety effects.

The edible composition may alternatively comprise a neutral non-starch polysaccharide. Especially preferred neutral non-starch polysaccharides are galactamannan, guar gum, locust bean gum, tara gum, ispaghula, β-glucans, konjacglucomannan, methylcellulose, gum tragacanth, detarium, tamarind or mixtures thereof. Of these, galactamannan, guar gum, locust bean gum and tara gum are especially preferred either on their own or in combination with other biopolymers.

A mixture of an ionic non-starch polysaccharide and a neutral non-starch polysaccharide may be used provided that the viscosity requirements according to the invention are met. If a such a mixture is used, the weight ratio of the ionic non-starch polysaccharide to the neutral non-starch polysaccharide is preferably in the range of from 5:1 to 1:5, more preferably 3:1 to 1:3, such as 2:1 to 1:2. For such a mixture, a mixture of alginate and guar gum is preferred.

It is preferred that the neutral non-starch polysaccharides have a weight average molecular weight of at least 3×10⁵, more preferably of at least 5×10⁵, most preferably of at least 7×10⁵. It is also preferred that these biopolymers have a molecular weight of up to 3×10⁶, more preferably of up to 2.5×10⁶, most preferably of up to 2.3×10⁶.

It is preferred according to the present invention that the edible compositions comprise less than 10% wt of a hydrolysed starch having a degree of polymerisation of at least 10, more preferably less than 5% wt, most preferably less than 2% wt. It is especially preferred that the edible compositions are substantially free from hydrolysed starch.

Divalent Metal Ion Source

The edible compositions of the invention may also comprise a divalent metal ion source. When the composition of the invention comprise an ionic non-starch polysaccharide which gels in the presence of a divalent metal ion, the presence of the latter is highly preferred.

Any suitable non-solubilised divalent metal ion source may be used. Calcium is a preferred divalent metal ion. Preferred are divalent metal ion salts which are substantially water insoluble, for example tricalcium phosphate and calcium carbonate.

The non-solubilised divalent metal ion source may be present in the edible composition through the addition of another ingredient therein, for example, through the addition of a milk source wherein colloidal calcium phosphate will be present.

The divalent metal ion source may be rendered non-solubilised by virtue of being encapsulated so that it does not predominantly dissolve in the product when it is not under gastric conditions. Preferably the non-solubilised divalent metal ion source is a salt which is predominantly insoluble under product conditions (when not under gastric conditions). The divalent metal ion source becomes predominantly solubilised under gastric conditions.

When used, the divalent metal ion source is present in an amount sufficient to form the gel strength of the invention, preferably in an amount of from 2 to 30% wt based on the weight of the biopolymer thickening agent, more preferably 5 to 20% wt, most preferably 7 to 15% wt.

Type of Composition

The edible composition according to the present invention is a liquid or spoonable composition.

The food composition may be any desired type having the above-mentioned physical format. Especially preferred food compositions are those which are intended to be used as part of a weight loss or weight control plan, such as a meal replacer product.

Suitable types of food compositions according to the invention include dairy or vegetable based drinks such as milk or soy based drinks; oil-in-water emulsions (such as dressings and mayonnaise); creams; desserts such as mousses, custards, rice or other similar puddings, yogurts; frozen confectionery including ice cream, water ices, sorbets, and frozen yoghurts; breakfast type cereal products such as porridge; soups, sauces, sport drinks and fruit juices etc.

Frozen confectionery may be a spoonable edible composition if it still meets the definition of a spoonable composition herein at the temperature at which it is consumed.

It is preferred that the food composition is a dairy or vegetable based drink, a dessert, a yogurt, or a soup. Meal replacement dairy or vegetable based drinks and soups are especially preferred.

The food compositions may be obtained from a powder or concentrate which is mixed with a liquid, e.g. water or milk, to produce a composition according to the invention.

The terms “meal replacer” or “meal replacement products” as used herein also include compositions which are eaten as part of a meal replacement weight loss or weight control plan, for example snack products which are not intended to replace a whole meal by themselves but which may be used with other such products to replace a meal or which are otherwise intended to be used in the plan; these latter products typically have a calorie content in the range of from 50-200 kilocalories per serving.

Meal replacers are generally used by consumers following a calorie controlled diet and are especially preferred food composition according to the invention. They have been found to be especially suitable as they can provide good satiety effects combined with restricted calorie content in a convenient form.

Other food compositions intended to be used as part of a weight loss or weight control plan typically have fewer calories per serving (or per 100 g of product) than their ‘non-diet’ equivalents. The calorie content of these foods is deliberately restricted accordingly. Examples include the so-called low-calorie options of every day foods. Meal replacer composition do not generally fall in this category as there may be no ‘full calorie equivalent’ product and also it is necessary to provide a reasonable number of calories per meal replaced.

Protein

The compositions of the invention comprise at least 1% wt protein.

Preferred sources for the protein which may be used in the present invention include dairy protein sources such as whole milk, skim milk, condensed milk, evaporated milk, milk solids non-fat, and mixtures thereof and includes whey proteins such as whey protein isolate and whey protein concentrate and caseins; egg proteins; vegetable protein sources such as soy, wheat, rice or pea and mixtures thereof; and animal sources of protein including gelatin. Soy and dairy proteins are particularly preferred according to the invention for dairy type food compositions such as drinks, puddings etc and animal proteins are preferred for savoury composition such as soups.

Especially preferred, to minimize the caloric impact, is the addition of protein as such rather than as one component of a food ingredient such as whole milk. Preferred in this respect are protein concentrates such as one or more of whey protein concentrate, milk protein concentrate, caseinates such as sodium and/or calcium caseinate and soy protein concentrates.

The protein may be present as the isolated protein, as a protein concentrate or as a protein hydrolysate.

The protein may be included in any suitable physical form, depending upon the type of edible composition, including as a powder or as nuggets as appropriate. Powder sources are typically most suitable for use according to the present invention for reasons of organoleptic properties.

The amount of protein in the compositions will vary according to the type of composition and also, where required, according to national or regional legislation.

It is preferred that the composition comprises at least 1.5% wt of protein based on the weight of the composition. Preferably the composition comprises protein in an amount of from 1.5 to 25% wt, preferably 2 to 20% wt.

It is further preferred that the protein provides up to 75% of the total calories of the composition, more preferably between 10% and 45%, most preferably between 15 and 40%.

Carbohydrate

The compositions of the invention preferably comprise carbohydrate.

The carbohydrates are preferably present in an amount of from 2 to 60% by weight based on the weight of the composition, more preferably 5 to 40% wt.

The amount of carbohydrate in the food composition will vary according to the composition and also, where required, according to national or regional legislation. The amounts of carbohydrate given herein, and the calories therefrom, are inclusive of the amount of any carbohydrate biopolymer present in the compositions.

Any suitable carbohydrates may be included in the edible compositions. Suitable examples include starches such as are contained in rice flour, flour, tapioca flour, tapioca starch and whole wheat flour, modified starches or mixtures thereof. Generally the edible compositions will be naturally sweetened and this is preferred as a source of carbohydrate. Suitable natural sweeteners include sugars and sugar sources such as sucrose, lactose, glucose, fructose, maltose, galactose, corn syrup (including high fructose corn syrup), sugar alcohols, maltodextrins, high maltose corn syrup, starch, glycerine, brown sugar and mixtures thereof.

Levels of sugars and sugar sources preferably result in sugar solids levels of up to 40 wt %, preferably from 5 to 20 wt % based on the weight of the edible compositions. The artificial sweeteners mentioned below as optional ingredients may also be used the whole, or a part, of the carbohydrate source.

The compositions preferably contain a total amount of from 0.1 to 10% wt dietary fibre, more preferably 0.2 to 7.5% wt, most preferably 0.5 to 5% wt, especially 1 to 3.5% wt. These amounts include any biopolymer thickening agent present in the composition that is a dietary fibre. Suitable fibre sources which may be included in the edible compositions of the invention, in addition to the biopolymer thickening agent, include fructose oligosaccharides such as inulin, soy fiber, fruit fibre e.g. apple, oat fiber, celluloses and mixtures thereof.

It is further preferred that the total amount of carbohydrate in the edible compositions provides from 10 to 80% of the total calories therein, more preferably 25 to 75%.

Fat

The compositions of the invention preferably comprise edible fats, preferably in an amount of up to 30% wt based on the weight of the composition, more preferably from 0.1 to 20% wt, most preferably from 0.2 to 10% wt fat, especially 0.5 to 5% wt.

According to the present invention, 50% or less of the kilocalories in the edible composition are preferably provided from the fat. It is more preferred that 40% or less of the kilocalories are provided from the fat, more preferably 5 to 20%.

The amount of fat will vary according to the composition and also, where required, according to national or regional legislation.

Any edible fat may be used for example, animal fats including fish oils, vegetable fats including plant oils, nut oils, seed oils, or mixtures thereof. Monosaturated and/or polyunsaturated fats and mixtures thereof are especially preferred although saturated fats can be used for taste reasons, e.g. butter, although these are less preferred on health grounds. Preferred polyunsaturated fats include omega 3 fatty acids, especially docosahexaenoic acid (DHA, C20:5) and/or eicosapentaenoic acid (EPA, C22:5). Preferred omega 3 fatty acids include the following C18:3, C18:4, C20:4, C20:5, C22:5 and C22:6.

Preferably the fat is selected from vegetable fats, such as for example, cocoa butter, illipe, shea, palm, palm kernal, sal, soybean, safflower, cottonseed, coconut, rapeseed, canola, corn and sunflower oils, tri and di-glyceride oils including linoleic acids and conjugated linoleic acids, linolenic acids, and mixtures thereof.

Aqueous Based Compositions

The compositions of the invention comprise water. Preferably the amount of water in the compositions (including any water present in other ingredients) is in the range of from 20 to 95% wt, more preferably from 30 to 90% wt.

Gastric Viscosity

The edible compositions preferably have a certain gastric viscosity as herein defined.

The ‘gastric viscosity’ value referred to herein is a measure of viscosity according to the method given hereinbelow and is used to simulate the viscosity of the ingested edible composition achieved in the stomach of the individual consuming it. When the gastric viscosity as according to the present invention is achieved, the satiety effect of the edible compositions is enhanced.

According to the present invention the edible compositions have a gastric viscosity as herein defined at 0.1 s⁻¹ and 37° C. of at least 20 Pa.s, preferably of at least 25 Pa.s, most preferably of at least 30 Pa.s, such as of at least 35 Pa.s. By “maximum” is meant that the gastric viscosity is no greater than this figure.

The edible compositions preferably have a maximum gastric viscosity as hereindefined at 0.1 s⁻¹ and 37° C. of 500 Pa.s, preferably of 400 Pa.s, most preferably of 300 Pa.s, especially of 200 Pa.s, such as 100 Pa.s.

The gastric viscosity as referred to herein is measured according to the following test procedure. The gastric viscosity is measured after 30 minutes.

Gastric Viscosity test method;

1. 325 ml of the edible composition is placed in a beaker, maintained at 37° C. and stirred using a suitable stirrer, e.g. a magnetic stirrer.
2. The composition is acidified instantaneously to pH 4.8 using 1M hydrochloric acid. 10 ml of the gastric juice described in point 3 below is added to represent the conditions found in a fasting stomach.
3. A peristaltic pump is set up so as to deliver two solutions, each at a pre-set rate of 0.523 ml/min over a period of about 30 minutes so that the pH of the edible composition is in the range of from 3.4 to 4.0 after 30 minutes.
   Solution 1: A mixture of 1M hydrochloric acid and 500 kU Pepsin per litre (Sigma Product No P7012; Activity: 2,500-3,500 units per mg protein).
   Solution 2: An artificial gastric juice mixture consisting of the following salts (per litre); 0.22 g CaCl₂, 2.2 g KCl, 5 g NaCl, 1.5 g NaHCO₃.
4. After the pH in point 2 is reached, 110 ml of the edible composition is removed and the viscosity measured using a Physica UDS 200 rheometer having a measuring cup of 24.4 mm radius and a roughened concentric cylinder having a radius of 22.5 mm and a length of 67.5 mm and an apex (available from Physica Meptechnik GmbH, Stuttgart, Germany). The roughened surface prevents slip occurring during testing to provide a more accurate measurement of viscosity. Viscosity is determined by incrementally increasing the shear stress over the range 0.1-100 Pa and maintaining the temperature at 37° C. using a temperature-controlled water bath. Viscosity-shear rate flow curves are generated for samples over approximately seven decades of shear (−10⁻⁴ to 10⁻³ s⁻¹) depending on properties of the edible composition. The viscosity at 0.1 s⁻¹ and 37° C. is taken from these flow curves.

The ‘viscosity of the composition’ value referred to herein is the viscosity of the composition measured according to the method in step 4. Thus the same rheological conditions are used but the composition is not subjected to the acidification step that is used to determine the gastric viscosity of the product.

Typically a meal replacement beverage has a viscosity before consumption (i.e. ‘viscosity of the composition’) in the range of from 0.005 to 0.5 at 0.1 s⁻¹ and 37° C.

The edible compositions of the invention are liquid or spoonable compositions which when consumed thicken in the stomach due to the acidic pH therein.

The gastric viscosity of the edible composition should be greater than viscosity of the composition. This means that the composition increases in viscosity at 0.1 s⁻¹ at 37° C. when undergoing acidification as would occur in the stomach upon consumption of the composition. This increase in viscosity to within the limits according to the present invention has been found to give good satiety benefits.

Optional Ingredients

The food composition of the invention may comprise one or more of the following optional ingredients.

The compositions of the invention may further comprise encapsulated satiety agents which are predominantly released in the intestines. Suitable satiety agents include lipids, especially mono, di or tri-glycerides, their free fatty acids, their edible salts, their non-glyceryl esters, hydrolyzable in the presence of gastro-intestinal enzymes, and mixtures thereof. These satiety agents may be encapsulated in any suitable cross-linked encapsulating agent whereby they are predominantly released in the intestines. Encapsulant materials comprising gelatin and at least one of gum arabic, carrageenan, agar agar, alginate or pectins, especially gelatin and gum arabic, have been found to be very suitable. These encapsulated satiety agents may be included in suitable amounts.

The composition may comprise one or more emulsifiers. Any suitable emulsifier may be used, for example lecithins, egg yolk, egg-derived emulsifiers, diacetyl tartaric esters of mono, di or tri glycerides or mono, di, or triglycerides. The composition may comprise an amount of from 0.05 to 10% by weight, preferably from 0.5% to 5% wt of the emulsifier based on the weight of the product.

Flavourings are preferably added to the edible compositions in amounts that will impart a mild, pleasant flavour. The flavouring may be any of the commercial flavours typically employed. When a non-savoury taste is desired the flavours are typically selected from varying types of cocoa, pure vanilla or artificial flavor, such as vanillin, ethyl vanillin, chocolate, malt, mint, yogurt powder, extracts, spices, such as cinnamon, nutmeg and ginger, mixtures thereof, and the like. It will be appreciated that many flavour variations may be obtained by combinations of the basic flavours. When a savoury taste is desired the flavours are typically selected from varying types of herbs and spices. Suitable flavourants may also include seasoning, such as salt, and imitation fruit or chocolate flavours either singly or in any suitable combination. Flavourings which mask off-tastes from vitamins and/or minerals and other ingredients are preferably included in the edible compositions.

The edible compositions may comprise one or more conventional colourants, in conventional amounts as desired.

The composition may also comprise 0.1 to 5% by weight of edible buffering salts based on the weight of the composition. Any suitable edible buffering salt may be used.

The composition may comprise up to 60% by weight of fruit or vegetables particles, concentrates, juice or puree based on the weight of the composition. Preferably the composition comprise 0.1 to 40% wt, more preferably 1 to 20% wt of these ingredients. The amount of these ingredients will depend upon the type of product; for example soups will typically comprise higher levels of vegetables than will a milk based meal replacement drink.

The composition may comprise one or more cholesterol lowering agents in conventional amounts. Any suitable, known, cholesterol lowering agent may be used, for example isoflavones, phytosterols, soy bean extracts, fish oil extracts, tea leaf extracts.

The composition may optionally comprise, in suitable amounts, one or more agents which may beneficially influence (post-prandial) energy metabolism and substrate utilisation, for example caffeine, flavonoids (including tea catechins, capsaicinoids and canitine).

The composition may comprise up to 10 or 20% by weight, based on the weight of the composition, of minor ingredients selected from added vitamins, added minerals, herbs, spices, antioxidants, preservatives or mixtures thereof. Preferably the compositions comprise an amount of from 0.05 to 15% by weight, more preferably 0.5 to 10% wt of these ingredients.

The composition preferably comprises added vitamins selected from at least one of; Vitamin A Palmitate, Thiamine Mononitrate (Vitamin B1), Riboflavin (Vitamin B2), Niacinamide (Vitamin B3), d-Calcium Pantothenate (Vitamin B5), Vitamin B6, Vitamin B11, Cyanocobalamin (Vitamin B12), biotin, Ascorbic acid (Vitamin C), Vitamin D, Tocopheryl Acetate (Vitamin E), Biotin (Vitamin H), and Vitamin K. The composition also preferably comprises added minerals selected from at least one of; calcium, magnesium, potassium, zinc, iron, cobalt, nickel, copper, iodine, manganese, molybdenum, phosphorus, selenium and chromium. The vitamins and/or minerals may be added by the use of vitamin premixes, mineral premixes and mixtures thereof or alternatively they may be added individually.

In particular the edible compositions preferably comprise alkaline metals such as sodium and/or potassium.

Calcium is preferably present in the edible compositions in amounts of from 5 to 50% of the amounts given in the European Commission Directive 96/8/EC of 26 February 1996 on foods intended for use in energy-restricted diets for weight reduction, more preferably about 10 to 35%, most preferably 15 to 35% per serving. Any suitable calcium source may be used. The calcium source may be used as a part, or the whole, of any calcium present as the non-solubilised divalent metal ion source.

It is preferred that the edible compositions comprise at potassium, especially in an amount of at least 300 mg of potassium per serving of the edible composition, more preferably 400-1000, most preferably 450-700 mg. Any suitable potassium source may be used.

One or more of the above-mentioned vitamins and minerals are preferably present at amounts of from 5 to 45% of the amounts given in the above European Commission Directive 96/8/EC, especially 5 to 40%, most especially 10 to 30%.

Other ingredients which may be present in the compositions include, but are not limited to, rolled oats, chocolate chips or other chocolate pieces, cookie and/or cookie dough pieces, fruit pieces, such as dried cranberry, apple, etc., vegetable pieces such as rice, honey and acidulants such as malic and citric acids. The type of edible composition will of course dictate the type and amount of optional ingredients used.

Calories/Serving Sizes

The edible compositions preferably have a calorie content in the range of from 50 kilocalories (kcals) to 500 kcals, more preferably 100 kcals to 400 kcals per serving. However, it will be understood that the calorie content per serving will vary according to the type of edible composition. For a dairy or soy based beverage or pudding the calorie content is typically in the range of from 50 kcals to 400 kcals, more preferably 100 or 150 kcals to 350 kcals, most preferably 200 kcals to 350 Kcals per serving. For a soup the calorie content is typically in the range of from 50 kcals to 350 kcals, more preferably 100 kcals to 250 kcals. These products may be consumed either to replace a meal (a meal replacer product) or as a snack product which is not intended to replace a meal.

If the edible composition is a meal replacer product the calorie content per serving is typically in the range of from 150 to 350 Kcal. If the edible composition is a product which is intended to be eaten as a snack product (i.e. not intended by itself to replace a whole meal) the calorie content per serving is typically in the range of from 50 to 150 Kcal.

The size of a serving of the edible composition will depend upon the type of composition. A serving of the edible composition as referred to herein refers to the amount of the edible composition that is intended to be consumed as a single portion, typically in a single sitting. For beverages and soups, the typical serving size is in the range of from 100 to 500 ml, preferably 150 to 400 ml, such as 200 to 350 ml. For puddings the typical serving size is in the range of from 75 g to 300 g, preferably 100 g to 250 g, such as 125 g to 200 g.

Manufacture

The composition of the invention may be prepared by any suitable conventional technique. Such techniques are well known to those skilled in the art and do not need to be described further here but may include mixing, blending, homogenising, high-pressure homogenising, emulsifying, dispersing, or extruding. The composition may be subject to a heat treatment step, for example pasteurisation or U.H.T. treatment.

Satiety and Consumption of the Composition

Consuming a composition according to the invention is intended to enhance and/or prolong the feeling of satiety for the consumer and/or extend the time interval between meals and/or reduce the amount of calories consumed in the following meal. This in turn aids the individual concerned to better adhere to a weight loss or weight control plan.

The consumption of a composition according to the invention may occur as a part of a dietary plan, such as those to reduce or control body weight.

The edible composition of the present invention may be consumed as desired. Preferably a composition is consumed at least daily in order to provide advantageous satiety effects, more preferably at least twice daily.

The food composition may be consumed by a human or an animal in connection with any one or more of the following; the treatment or prevention of obesity or being overweight; to improve or maintain the perception of body image; aiding compliance with a dietary plan e.g. to control, reduce or maintain body weight, including maintenance of desired body weight following previous weight loss; to extend the time elapsed between taking meals; to control, maintain or reduce daily calorie intake; to suppress appetite. The subject following that plan may be thus better able to reduce, control or maintain their body weight, e.g. by following the dietary plan for a longer period of time and/or adhering more closely to the plan as they feel less temptation to snack or over-eat.

The term “weight control or weight loss plan” as used herein includes regimes, plans and diets followed for controlling body weight and also those followed for medical reasons e.g. to loose weight or to aid other health problems adversely affected by being overweight or obese.

The invention is further exemplified by the following examples, which are to be understood as to be non-limiting. Further examples within the scope of the invention will be apparent to the person skilled in the art.

### EXAMPLES

### Example 1

1.75% Protanal LF5/60 (alginate with an L-guluronic acid content of 69% and a weight average molecular weight of 1.0−1.2×10⁵, available from FMC Biopolymer) was added to a commercially available meal replacement beverage (US Slim*Fast™ Chocolate Royale Ready-to-drink beverage, purchased in cans from the same batch) by the method given below, such that 325 ml of the beverage contained 5.69 g of the alginate. The meal replacement beverage comprised about 6.6 g of protein.

The cans were shaken, opened and weighed and brought over in a Wolff food processor. The alginate, lactulose (5 g, added for intestinal transit time calculation) and tricalcium phosphate (10% wt based on the weight of alginate) were blended and mixed in at a speed of 1500 rpm for 2 minutes at ambient temperature. The mixture was then vacuumed and mixed for a further 5 minutes. The Wolff jacket was heated with steam until the content was at 60° C. and mixed at this temperature for 15 minutes at 1500 rpm. The mixture was then poured in a UHT plant premix tank and slowly stirred during further processing. UHT processing was carried out by heating to 78-85° C., sterilisation at 140° C. for 9 seconds and cooling to 9° C. in two steps without a homogenisation step. The drink was then filled in aseptic transparent bags containing approximately 1.0-1.5 kg. The sample bags were then stored at 5-7° C. until use.

The gel strength of the edible composition was determined according to the gel strength test defined above in the detailed description. The gel strength at 37° C. and pH 2 was 16 KPa.

The Protanal was determined to be present in the polysaccharide continuous phase of the composition by Confocal Microscopy and Raman Spectroscopy. The amount of Protanal in the polysaccharide continuous phase was estimated by Confocal Scanning Laser Microscopy (CSLM) using suitable image analysis software, as is readily available, to be about 4.05% wt, based on the weight of the polysaccharide continuous phase.

The satiety effect of the edible composition was tested upon 25 human volunteers using the following test conditions. The volunteers entered the study centre at 11.30 am, after consuming a standard breakfast at their own home. The edible composition was consumed at 12:00 and satiety was determined before consumption and for five hours following consumption of the test meal. A VARS (Visual Analogue Rating Scale) questionnaire was used in order to determine a number of satiety parameters (fullness, hunger, appetite).

A control test meal was also consumed by the same volunteers on a different day. The control test meal was the same commercially available meal replacement beverage but without the added alginate and tricalcium phosphate. The gastric viscosity of the control test meal was determined according to the gastric viscosity test defined above in the detailed description. The gel strength of the control meal at 37° C. and pH 2 was approximately 370 Pa.

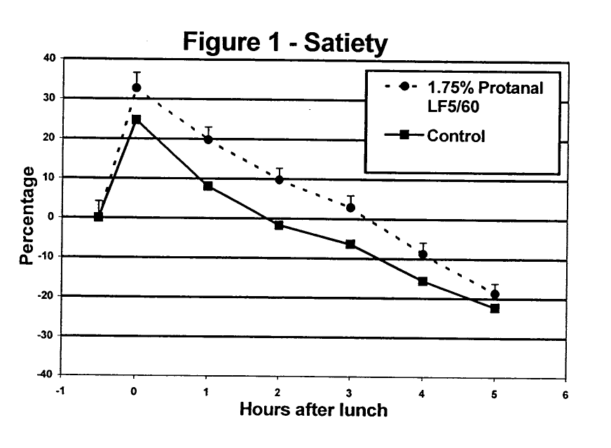

FIG. 1 shows the reported satiety of the subjects over time after consuming the compositions of the invention and the control meal.

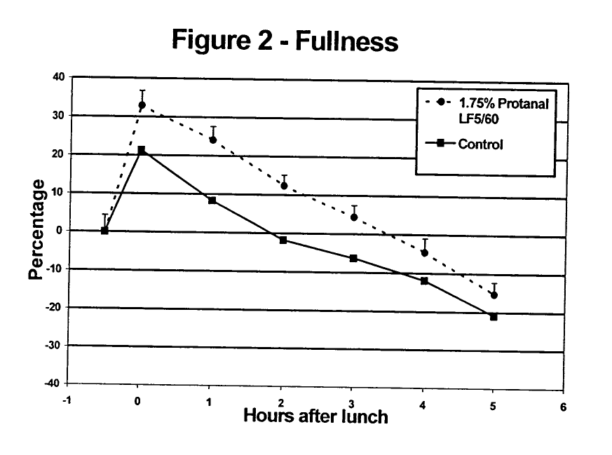

FIG. 2 shows the reported feeling of fullness of the subjects over time after consuming the compositions of the invention and the control meal.

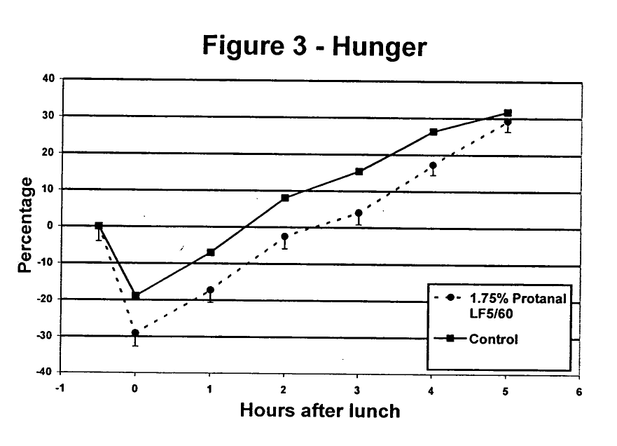

FIG. 3 shows the reported feeling of hunger of the subjects over time after consuming the compositions of the invention and the control meal.

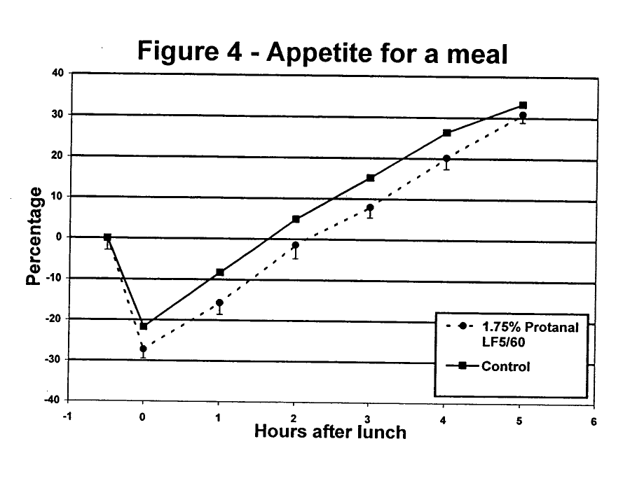

FIG. 4 shows the reported appetite for a meal of the subjects over time after consuming the compositions of the invention and the control meal.

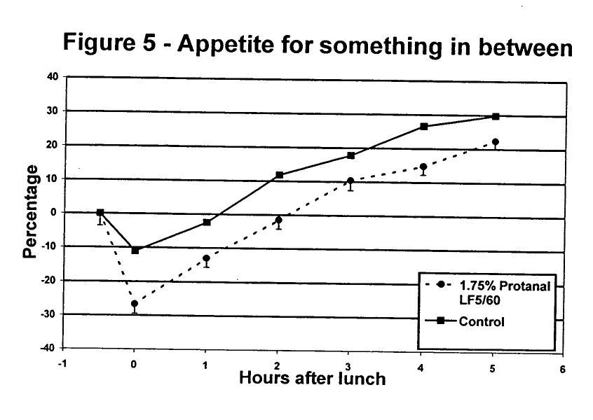

FIG. 5 shows the reported appetite for something in-between (a snack) of the subjects over time after consuming the compositions of the invention and the control meal.

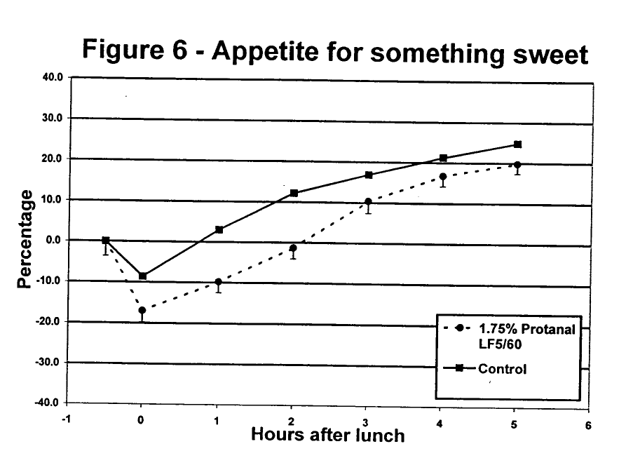

FIG. 6 shows the reported appetite for something sweet of the subjects over time after consuming the compositions of the invention and the control meal.

Statistical analysis were carried out according to a Dunnet test. The area under the curve of the satiety scores was measured and all parameters analysed using regression analysis.

All satiety parameters (satiety, hunger, fullness, appetite for a meal, appetite for something in between) were significantly different between the 1.75% Protanal LF5/60™ and control test meals at p<0.05.

The above results demonstrate that the edible compositions of the invention have a significant statistical improvement on the satiety effect compared to other compositions.

### Example 2

A control composition was prepared according to the formulation given in Table 1 below. All weights are given as percentages by weight based on the total weight of the control composition.

TABLE 1

| | % by weight |
|---|---|
| Water | 86.60 |
| Skimmed Milk Powder (SMP) | 6.50 |
| Sucrose | 4.05 |
| Calcium Caseinate | 1.60 |
| Flavour (French Vanilla) | 0.54 |
| Canola Oil | 0.33 |
| Lecithin | 0.10 |
| Emulsifier | 0.09 |
| Total | 100% |

The control composition was prepared as follows. The water was heated to 50° C. and pre-blended Skimmed Milk Powder (SMP), caseinate and sucrose was added and mixed. This mixture was heated to 55° C. and mixed with an Ultra-Turrax for 15 minutes. The pre-heated fat phase (>60° C.) (oil, lecithin and emulsifier) was added and mixed for 2 minutes. This mixture was homogenised in two-stages; 100/40 bars (Niro homogeniser: throughput ˜14 kg/hr; back pressure 4 bar) and then sterilised using a small UHT line (heating/holding section at 145° C.; cooling section at 72° C.). The samples were filled in a flow cabinet into 250 ml bottles and cooled in ice water.

1.0% Manugel DMB™ (alginate with an L-guluronic acid content of 72% and a weight average molecular weight of 2.83×10⁵, available from ISP/Kelco) was added, by the method given below, such that 325 ml of the composition contained 3.25 g of the alginate. This provided a composition according to the invention. The SMP provided the non-soluble divalent metal source (which was a mixture of different salts naturally occurring in SMP) at a level of 8.32% wt based on the weight of the alginate.

The control composition was stirred using a magnetic stirrer and the Manugel DMB™ alginate was sprinkled into the solution at room temperature. The composition was then heated to 80° C. for 10 minutes, the temperature then reduced to 37° C. and maintained for 2 hours with continued stirring.

The control composition comprised about 7.9 g of protein.

The gel strength of the composition comprising the alginate was determined according to gel strength test defined above in the detailed description. The gel strength at 37° C. and pH 2 was 11 KPa. The gel strength of the control was 450 Pa.

Addition of the Manugel DMB™ alginate to the edible control composition produced a polysaccharide continuous system determined by Confocal Microscopy and Raman Spectroscopy.

The satiety effect of the edible composition was tested upon 12 human volunteers using the following test conditions. The volunteers fasted overnight, abstained from alcohol for the previous 24 hours and caffeine and strenuous exercise for the previous 18 hours. The test meals were randomised according to the Latin Squares procedure. A satiety questionnaire was carried out before ingestion of the meals and 4 hours after ingestion. 500 ml of water was consumed 2 hours after ingestion of the test meals. The results were statistically significant for a number of satiety scores (hunger, fullness, appetite) at a number of time points (see figures).

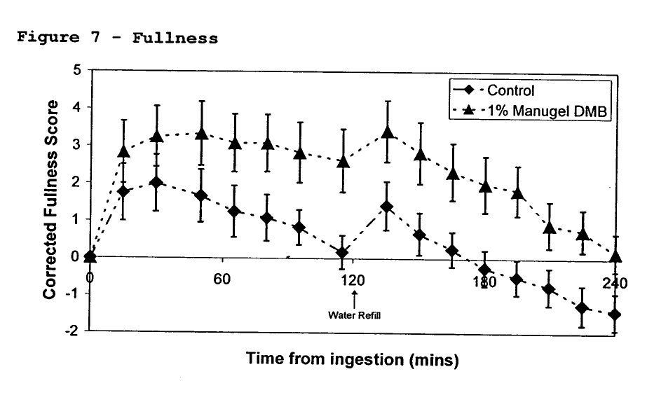

FIG. 7 shows the reported feeling of fullness of the subjects over time after consuming the compositions of the invention and the control meal.

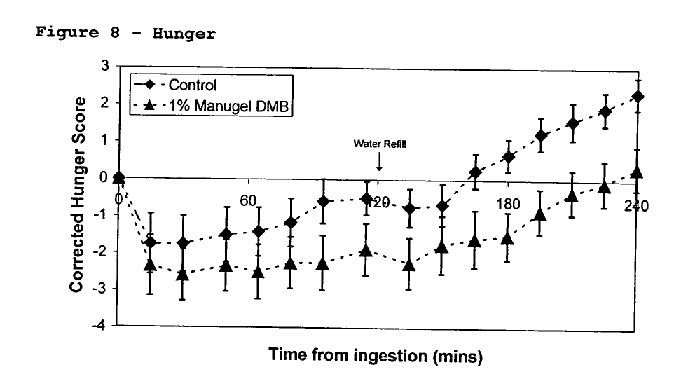

FIG. 8 shows the reported feeling of hunger of the subjects over time after consuming the compositions of the invention and the control meal.

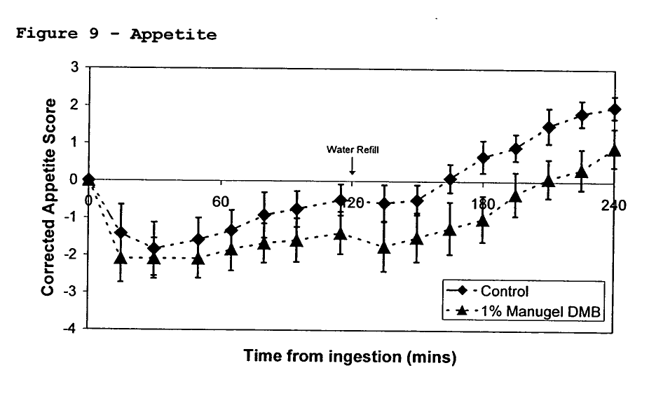

FIG. 9 shows the reported feeling of appetite of the subjects over time after consuming the compositions of the invention and the control meal.

TABLE 2
P-values from Wilcoxon Signed Ranks Tests for areas
under normalised questionnaire time series curves comparing 1%
Manugel DMB ™ and with the control meals.

| | |
|---|---|
| Fullness | 0.031* |
| 115 minutes | |
| Fullness | 0.028* |
| 240 minutes | |
| Hunger | 0.041* |
| 115 minutes | |
| Hunger | 0.041* |
| 240 minutes | |
| Appetite | 0.182 |
| 115 minutes | |
| Appetite | 0.045* |
| 240 minutes | |

*statistically significant (p < 0.05)

The above results demonstrate that the edible compositions of the invention have a significant statistical improvement on the satiety effect in the test subject compared to the control composition.

### Example 3

0.8% Manugel DMB™ (see example 2) was added to a commercially available meal replacement beverage (US Slim*Fast™ Chocolate Royale Ready-to-drink beverage, purchased in cans from the same batch) by the method given below, such that 325 ml of the beverage contained 2.6 g of the alginate. The meal replacement beverage comprised about 6.6 g of protein.

The beverage was stirred using a magnetic stirrer and the Manugel DMB™ alginate was sprinkled into it at room temperature. The composition was then heated to 80° C. for 10 minutes, the temperature then reduced to 37° C. and maintained for 2 hours with continued stirring. The gel strength of the composition comprising the alginate was determined according to gel strength test defined above in the detailed description. The gel strength at 37° C. and pH2 was 17.5 Kpa according to the test results which was greater than the gel strength of the edible composition (approximately 370 Pa).

The Manugel was determined to be present in the polysaccharide continuous phase of the composition by Confocal Microscopy and Raman Spectroscopy. The amount of Manugel in the polysaccharide continuous phase was estimated by Confocal Scanning Laser Microscopy (CSLM) using suitable image analysis software, as is readily available, to be about 1.85% wt, based on the weight of the polysaccharide continuous phase.

The satiety effect of the edible composition was tested upon 30 human volunteers using the following test conditions. Prior to coming to the test centre, volunteers were instructed to consume no alcohol and no food after 10 pm on the day before the study, to consume a normal breakfast at home before 9 am, to consume nothing else except water, tea or coffee for the rest of the morning and to undertake no vigorous physical activity. The study was conducted using a randomised single-blind, cross-over, repeated measures design. The edible compositions were served at 12 pm at 8-120° C., followed by 30 ml water. Post-prandial satiety and mood were measured at half hourly intervals across the afternoon using Visual Analogue Scales (VAS) and a Food Checklist, and subsequent food intake was measured at 5.30 pm using an ad-libitum cold buffet meal.

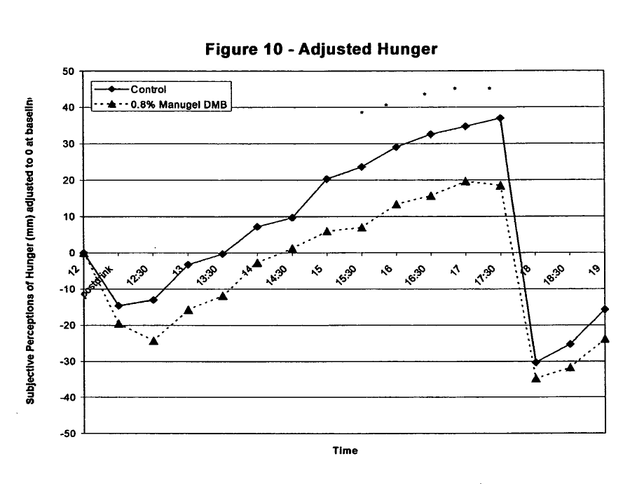

FIG. 10 shows the reported (adjusted) feeling of hunger of the subjects over time after consuming the compositions of example 3.

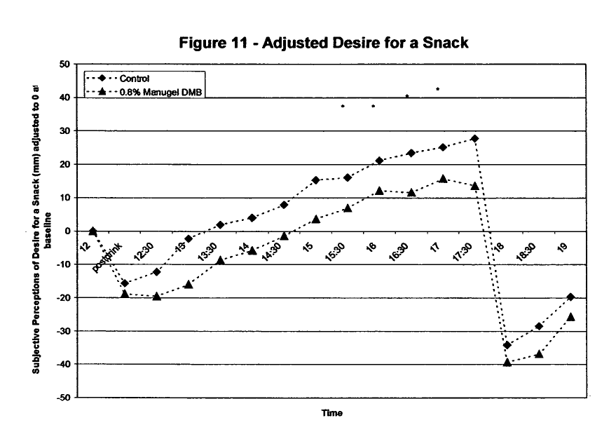

FIG. 11 shows the reported (adjusted) desire for a snack of the subjects over time after consuming the compositions of example 3.

Subjective satiety ratings were analysed using repeated measures analysis of variants (ANOVA). For subjective appetite ratings adjusted to 0 at baseline, effects of condition were found in scales of hunger and desire for a snack (P=<0.05).

The above results demonstrate that the edible compositions of the invention have a significant statistical improvement on the satiety effect compared to the control compositions.

1. An aqueous liquid or spoonable edible composition comprising at least about 1% wt protein and from about 0.1 to about 5% wt of a biopolymer thickening agent which is not denatured or hydrolysed between about pH 2 and about pH 4, and wherein the composition has a gel strength at about 37° C. and about pH 2 of at least about 10 KPa.

2. An edible composition according to claim 1, wherein the composition has a gel strength at about 37° C. and about pH 2 of at least about 15 KPa.

3. An edible composition according to claim 1, wherein the composition has a maximum gel strength at about 37° C. and about pH 2 of about 100 KPa.

4. An edible composition according to claim 1, wherein the composition comprises a polysaccharide continuous phase comprising at least a part of the biopolymer thickening agent.

5. An edible composition according to claim 4, wherein the polysaccharide continuous phase comprises from about 0.5 to about 10% wt of the biopolymer thickening agent based on the weight of the polysaccharide continuous phase.

6. An edible composition according to claim 1, wherein the biopolymer thickening agent comprises a non-starch polysaccharide.

7. An edible composition according to claim 6, wherein the biopolymer thickening agent comprises an ionic non-starch polysaccharide.

8. An edible composition according to claim 7, wherein the ionic non-starch polysaccharide is present in an amount of from about 0.5 to about 3% wt based on the weight of the composition.

9. An edible composition according to claim 7, wherein the ionic non-starch polysaccharide is selected from the group consisting of alginate, pectin, carrageenan, amidated pectin, xanthan, gellan, furcellaran, karaya gum, rhamsan, welan, gum ghatti, gum arabic and salts and mixtures thereof.

10. An edible composition according to claim 9, wherein the alginate has a L-guluronic acid content of at least about 60% of the total uronic acid units in the alginate.

11. An edible composition according to claim 9, wherein the alginate has a molecular weight of at least about 0.5×10⁵.

12. An edible composition according to claim 6, wherein the biopolymer thickening agent comprises a neutral non-starch polysaccharide.

13. An edible composition according to claim 12, wherein the neutral non-starch polysaccharide is selected from the group consisting of galactamannan, guar gum, locust bean gum, tara gum, ispaghula, β-glucans, konjacglucomannan, methylcellulose, gum tragacanth, detarium, tamarind and mixtures thereof.

14. An edible composition according to claim 12, wherein the neutral non-starch polysaccharides have a weight average molecular weight of at least about 3×10⁵.

15. An edible composition according to claim 1, wherein edible composition further comprises a source of non-solubilised divalent metal ions.

16. An edible composition according to claim 15 wherein the source of non-solubilised divalent metal ions is present in an amount of from about 2 to about 30% wt based on the weight of the biopolymer thickening agent.

17. An edible composition according to claim 1, wherein the composition comprises from about 2 to about 20% wt protein.

18. An edible composition according to claim 1, wherein the composition comprises water in an amount from about 20 to about 95% wt.

19. An edible composition according claim 1, wherein the edible composition is a meal replacer or other food product for use in a weight loss or weight control plan.

20. The use of a biopolymer thickening agent which is not denatured or hydrolysed between about pH 2 and about pH 4 in the manufacture of an aqueous liquid or spoonable edible composition comprising at least about 1% wt and having a protein gel strength at about 37° C. and about pH 2 of at least about 10 KPa, for use in providing an enhanced feeling of satiety to a person consuming the edible composition and/or to aid adherence to a weight loss or weight control plan and/or in a method of preventing or treating obesity or being overweight.

21. A method for inducing satiety in a human or animal, the method comprising the step of administering to a human or animal an aqueous liquid or spoonable edible composition comprising at least about 1% wt protein and from about 0.1 to about 5% wt of a biopolymer thickening agent which is not denatured or hydrolysed between about pH 2 and about pH 4, the edible composition having a gel strength at about 37° C. and about pH 2 of at least about 10 KPa.
